(19) United States
(12) Patent Application Publication
(10) Pub. No.: US 2013/0212371 A1
(43) Pub. Date: Aug. 15, 2013

(54) System Property Manipulation

(71) Applicants: Marcus Swenson, Duvall, WA (US); Scott McMurray, Redmond, WA (US); Chris Saam, Redmond, WA (US)

(72) Inventors: Marcus Swenson, Duvall, WA (US); Scott McMurray, Redmond, WA (US); Chris Saam, Redmond, WA (US)

(73) Assignee: Microsoft Corporation, Redmond, WA (US)

(21) Appl. No.: 13/370,334

(22) Filed: Feb. 10, 2012

(51) Int. Cl. G06F 9/00

(52) U.S. Cl. 713/100

(57) ABSTRACT

A system and method for modifying a system property, such as a system time. A time offset may be passed between computing devices by including it in a request message. On a computing device, the time offset may be stored in an apartment corresponding to the received request. The apartment may be stored in thread logical data, accessible to any thread that performs actions related to the request. The apartment with the time offset may be passed between computing devices by including it in a request message. On a particular device, the apartment and time offset may be retrieved to determine an adjusted time. The system may be used by a client to perform tests or to recover from failures without disturbing the system time. System properties other than system time may be adjusted with the mechanisms described.

### BACKGROUND

Computers generally have a number of system properties that may be accessed and used by applications. Examples of such system properties include time and date, geographic location, language, and the like. There may be situations when a software developer or administrator has a need to use a different time than that maintained by the system. For example, a developer may want to test a program by simulating a time other than the current time. In another example, after a system has failed, an administrator may want to perform an operation as if it occurred during a time in the past.

One way to achieve these needs is to directly modify the system properties. For example, a developer or administrator can modify the system time to a time in the past, execute a program or perform an operation, and reset the system time to the current time. However, such a solution may be incomplete or may result in undesired side effects. For example, other applications, users, or operations, or the system itself, may be subject to the modified system time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, in one embodiment, a system, method, and components operate to modify a system property corresponding to a request for a service. Mechanisms may include receiving a service request, the request including a property adjustment, creating and storing the property adjustment in an apartment corresponding to the service request and, in response to a request for an adjusted system property corresponding to the service request, retrieving the property adjustment and determining an adjusted system property corresponding to the request based on the system property and the property adjustment.

In one embodiment, the system property is system time and the adjusted system property is a time offset specification.

In one embodiment, the request is sent from a first computing device to a second computing device. The time offset specification may be passed in a request message.

In one embodiment, the apartment is stored in a logical call context corresponding to the service request, enabling two or more threads that perform operations corresponding to the request for service to retrieve the apartment.

In one aspect of the mechanisms described herein, multiple service requests may be received, each request having a corresponding time offset. Each time offset may be stored in a corresponding apartment, enabling program code operating on each request to retrieve the corresponding time offset and determine a corresponding adjusted time.

The mechanisms described may be used to simulate performing operations at a time different from the system time, enabling testing or failure recovery without disturbing the system time or processes performing other operations.

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of an example computer-based system in which mechanisms described herein may be deployed;

FIG. 2 is a block diagram of another example computer-based system in which mechanisms described herein may be deployed;

FIG. 3 is a block diagram of an example computer-based system for adjusting system time data, in which mechanisms described herein may be deployed;

FIG. 4 is a flow diagram illustrating an example embodiment of a process for manipulating a system property, in accordance with some of the mechanisms described herein;

FIG. 5 is a flow diagram illustrating an example embodiment of a process for using a manipulated system property, in accordance with some of the mechanisms described herein;

FIG. 6 is a flow diagram illustrating an example embodiment of a process for adjusting system time data, in accordance with some of the mechanisms described herein; and

FIG. 7 is a block diagram showing one embodiment of a computing device, illustrating selected components of a computing device that may be used to implement mechanisms described herein.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “processor” refers to a physical component such as an integrated circuit that may include integrated logic to perform actions.

As used herein, the term “thread” refers to a thread of execution. A thread may be a software thread or a hardware thread. In a hardware multi-threaded processor, two or more threads may concurrently exist on the processor. Some processors provide multiple sets of registers or other components, so that multiple hardware threads may each have their own set of registers. A hardware multi-threaded processor may have a number of software threads that is greater than the number of hardware threads it supports. An operating system may manage the software threads, providing each a turn at executing as a hardware thread.

As used herein, a multi-threaded system is a system that supports multiple threads, which may be software or hardware threads. A multi-threaded system may or may not have hardware support for multi-threading.

As used herein, the term “pointer” refers to a reference to a target physical or logical memory location, data structure, program instruction, or program segment. A pointer “points to” a target and may be used to locate or obtain the target. A pointer may be implemented in a variety of ways, including an address, an offset, an index, or an identifier.

As used herein, the term “time” refers to data that specifies a date, a time of day, or a combination thereof. Time may be represented in a variety of ways, such as a number of seconds after a designated base time, a year/day/minute specification, or in another manner. The term “system time” refers to a setting of a system clock that indicates a time of the computer system. Typically, each computing device has its own system clock that keeps track of system time.

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on non-transitory computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both non-transitory storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

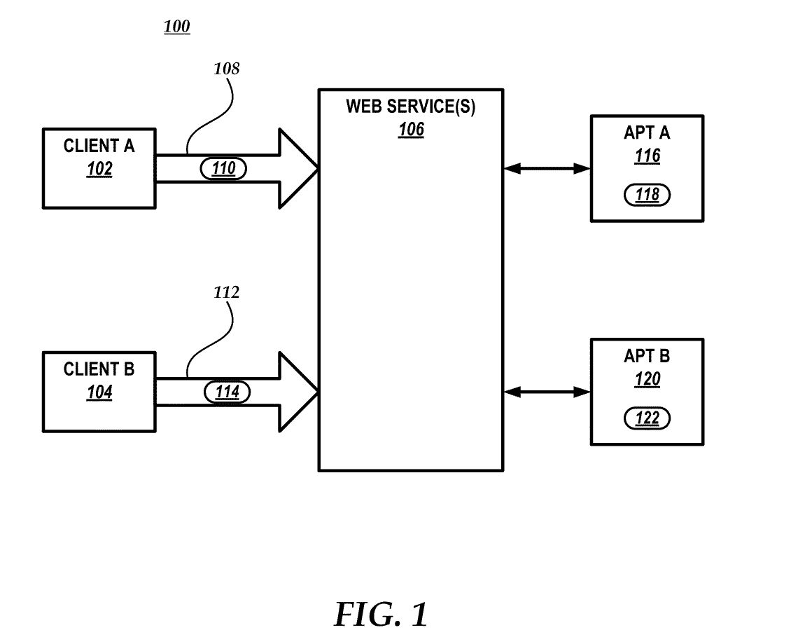

FIG. 1 is a block diagram of an example computer-based system 100 in which embodiments may be practiced. FIG. 1 provides a basic understanding of an example system, though many configurations may be employed and many details are not illustrated in FIG. 1. In one embodiment, system 100 exists within a cloud computing environment, or simply, a cloud. A cloud may be thought of as a computer network including multiple computing devices, components integrated with or accessed by computing devices, or mechanisms for communicating among computing devices or component. Components of a cloud may be physically located in one or more data centers. They are device and location independent, in that a client or user need not know the actual device or location where a component resides. In one embodiment, a cloud includes the Internet, which is a network of networks. The cloud may include wired communication mechanisms, wireless communication mechanisms, or a combination thereof. System 100 may employ any one or more of these mechanisms.

As illustrated in FIG. 1, an example system 100 includes client A 102 and client B 104. In various configurations, system 100 may include one or many clients. A client may include a computing device and a software application executing thereon. Multiple clients may reside on a common computing device. It is understood that an application or process may be implemented by one or more software modules that operate to perform the functions of an application or process.

Each of client A 102 and client B 104 may communicate with Web service 106. Web service 106 may include one or more Web services or components thereof that operate in a coordinated manner to provide one or more services to each client. Examples of services include storing, retrieving, providing, or otherwise manipulating data, maintaining a subscription, payment systems, compute services, backup services, or other services. The multiple Web services 106 may be performed by one or more processors on a single device, on multiple respective devices, or distributed among multiple devices in a variety of configurations.

As illustrated in FIG. 1, in an example embodiment, client A 102 may send a request 108 to Web service 106. The request may be a request to perform one or more operations related to the service provided by Web service 106. Request 108 may include a system property adjustment specification. FIG. 1 illustrates time offset specification 110 included in request 108, though specifications of adjustments to other system properties may be used. Time offset specification 110 is a specific example of a system property adjustment specification that may be used in various embodiments. In one embodiment, time offset specification 110 is embedded in a header of a message carrying request 108. The body of the message may carry data that is to be used by the business logic of the Web service. For example, the body may include Web service commands, parameters to the commands, login or authentication data, data to be stored or processed by the Web service, or other data. In one implementation, request 108 is contained within a Windows Communication Foundation (WCF) message, and time offset specification 110 is included in a WCF header, though other protocols may be used in various implementations. In a heterogeneous environment, such as the Internet, multiple protocols may be used to communicate between various devices as part of an implementation.

A system employing mechanisms described herein may include one or more clients. FIG. 1 illustrates a second client, client B 104, which sends service request 112 including time offset specification 114, to Web service 106. Various systems may include any number of clients sending requests. Each client may send one or multiple requests, each having its own time offset specification.

In the example system of FIG. 1, Web service 106 communicates with apartment A 116 and apartment B 120. An apartment is a conceptual construct that includes data corresponding to a service request. In one embodiment, each request received by Web service 106 may have a corresponding apartment. An apartment may be implemented in a variety of ways. An apartment may be copied, and a copy may be passed among two or more components. In the example of FIG. 1, apartment A 116 includes time offset specification 118, which corresponds to time offset specification 110; apartment B 120 includes time offset specification 122, which corresponds to time offset specification 114. It may be said that request 108 includes an apartment that is a representation of apartment A 116, and request 112 includes an apartment that is a representation of apartment B 120. In one embodiment, in response to receiving each request 108 or 112, Web service 106 creates a corresponding apartment, inserting the time offset specification 110 or 114, respectively. Thus, FIG. 1 illustrates an apartment being transferred from each of client A 102 and client B 104 to Web service 106.

Though apartment A 116 and apartment B 120 are illustrated outside of Web service 106, in some implementations, each apartment may be stored within Web service 106, on a common device, or external to Web service 106 but accessed by the Web service.

In one embodiment, when Web service 106 performs operations relating to request 108, it uses data from apartment A 116, including time offset specification 118; when Web service 106 performs operations relating to request 112, it uses data from apartment B 120, including time offset specification 122.

In one embodiment, system 100, or portions thereof, run on the Windows Azure™ Platform, by Microsoft. Windows Azure™ includes an operating system that provides scalable compute and storage facilities, hosted in one or more data centers. This enables application providers to run their applications and services in a cloud environment, such as illustrated in FIG. 1. The mechanisms described herein are not, however, limited to this platform, and may be employed with various other cloud computing platforms. Portions of system 100 may execute on a virtual machine, such as those provided by Windows Azure™.

Communications between computing devices of system 100 may employ one or more of various wired or wireless communication protocols, such as IP, TCP/IP, UDP, HTTP, SSL, TLS, FTP, SMTP, WAP, Bluetooth, or WLAN.

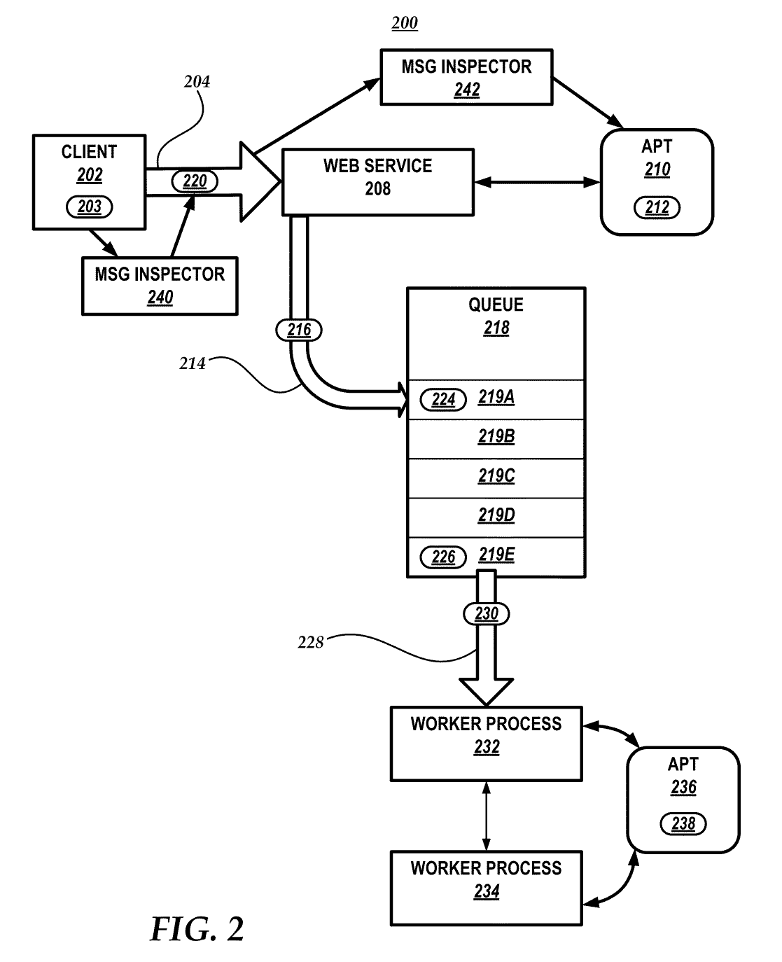

FIG. 2 is a block diagram of another example computer-based system 200 in which mechanisms described herein may be deployed. For simplicity, system 200 only includes one client 202, though it may be expanded to include any number of clients.

Adjusted time 203 is a modification of the system time. It may be set by a person at the client device, or set automatically by program code configured to set the adjusted time corresponding to client 202. The adjusted time may be a time that is desired to be used by services performing operations related to a request by client 202. For example, if it is desired to simulate operations performed two days prior, adjusted time 203 may be set to be the date and time of two days prior to the present time.

As illustrated in FIG. 2, client 202 sends a request 204 containing time offset specification 220 to Web service 208. Client 202, request 204, and time offset specification may be client A 102, request 108, and time offset specification 110 of FIG. 1, and the description of the FIG. 1 applies to the corresponding FIG. 2 components.

In one embodiment, outgoing message inspector 240 may perform the action of inserting time offset specification 220 into request 204. It may, for example, process a preliminary message created by client 202, retrieve adjusted time 203 from client 202, and determine a time offset specification based on the adjusted time 203 and the system time. It may then embed time offset specification 220 in request 204, or a transformation thereof. As discussed herein, in one implementation, the time offset specification may be embedded in a WCF header, a header of another protocol, or a message body.

In FIG. 2, Web service 106 has been shown in more detail to include Web service 208, queue 218, worker process 232, and worker process 234. In one configuration, worker processes 232 and 234 reside on one computing device, while each of Web service 208 and queue 218 reside on separate computing devices. However, in various configurations, each of these four components may be distributed among one or more computing devices.

As illustrated in the example of FIG. 2, apartment 210, containing time offset specification 212, corresponds to request 204 and time offset specification 220. More specifically, time offset specification 212 may be a copy of time offset specification 220. Apartment 210 may be apartment A 116 of FIG. 1. Web service 208 may create apartment 210 in response to receiving request 204. In one embodiment, incoming message inspector 242 may perform the action of inserting time offset specification 212 in apartment 210. It may, for example, process an incoming request message received by Web service 208, retrieve time offset specification 220 from the incoming message, create apartment 210 corresponding to the request, and store time offset specification 220 as time offset specification 212 in apartment 210. Thus, in some embodiments, outgoing message inspector 240 and incoming message inspector 242 may perform complimentary actions to transfer a time offset specification from a client to a Web service apartment.

In response to receiving request 204, Web service 208 may enter the request onto queue 218. In various implementations, this may be performed by sending a message, invoking a method, or other mechanism. Message 214 represents the various implementations of providing a request to be queued. Message 214 contains time offset specification 216, corresponding to request 204 and time offset specification 220 and apartment 210 with time offset specification 212. The data of message 214 may be considered to be a representation of apartment 210.

Each entry 219A-E of queue 218 may contain a representation of a corresponding apartment, as passed by a corresponding Web service request. As illustrated, queue entry 219A, containing time offset specification 224, may be considered to be an apartment corresponding to message 214 and apartment 210. Each other entry may have its own corresponding incoming message, apartment with a time offset specification, and request message.

The apartment of entry 219A may be implemented in a variety of ways, including a pointer to the actual data, or an ID that can be used to retrieve the data. Thus, the figure showing the data within the queue is to be considered a conceptual representation, and not necessarily a physical representation.

As illustrated in the example of FIG. 2, worker process 232 may retrieve entries from queue 218. Entry 219E may be the front of the queue from where entries are removed, while entry 219A may be the back of the queue, where entries are inserted. Thus, worker process 232 is illustrated retrieving and removing entry 219E, containing time offset specification 226, from queue 218.

As discussed for message 214, retrieving a queue entry may be implemented in a variety of ways, including messages or method invocations, or passing a physical representation. Message 228, containing time offset specification 230, represents the various implementations. Data of message 228 may be considered to be another representation of apartment 210. As discussed for request 204, message 228 may include an apartment representation in its header.

In one implementation, in response to receiving queue entry 219E, worker process 232 may create apartment 236 containing time offset specification 238, corresponding to, and having the data of, message 228 and queue entry 219E. Though message 228 and apartment 236 are illustrated as corresponding to queue entry 219E, when queue entry 219A is retrieved, the retrieval message and the resulting apartment will correspond to, and have the data of, request 204, message 214, and apartment 210.

Worker process 234 is another process that may perform operations related to a retrieved queue entry. In one configuration, worker process 234 and worker process 232 reside on a common computing device and share apartment 236. In one embodiment, each of worker process 234 and worker process 232 are threads; each may share thread logical data, and apartment 236 may be stored in a logical call context. A logical call context is a mechanism that may be used to store data and to pass it along to a series of execution components that perform operations corresponding to the request, though the series of execution components may include operations by one or more hardware or software threads. Each such thread may retrieve the apartment or time offset specification from the logical call context. At a subsequent time, a thread that performs operations corresponding to a first request may perform operations corresponding to a second request. While processing the second request, the thread may retrieve the apartment or time offset specification corresponding to the second request. Thus, apartments and time offset specifications correspond to a request, rather than to the threads that handle the request.

As illustrated by FIG. 2 and discussed herein, an apartment, or the portion thereof, containing a time offset specification, may be passed between computing devices by using messages, such as request 204, message 214, or message 228. The apartment, or the data thereof, may be passed between threads within a computing device by using a logical call context or other mechanism for sharing data among threads. These mechanisms may be used to maintain the time offset data throughout the lifetime of a request, as the requested service is performed by multiple components.

In some embodiments, a system property other than time may be the property that is being adjusted by the mechanisms illustrated and described herein. Geographic region, language, domain name, email address, URL, or user name are examples of other system properties that may be adjusted. In some embodiments, the mechanisms described may be used to adjust application data, such as a logging threshold, a discount percentage, an email template, or other application data. When using a system property such as region, language, or domain name, the adjustment specification may be the ID of the adjusted property. For example, if the system property of language is “American English,” the adjustment specification may be “French.” Thus, time offset specifications 220, 212, 216, 224, 226, 230, 238, and other time offset specifications illustrated or discussed herein are examples of system property adjustments that may be used in various embodiments.

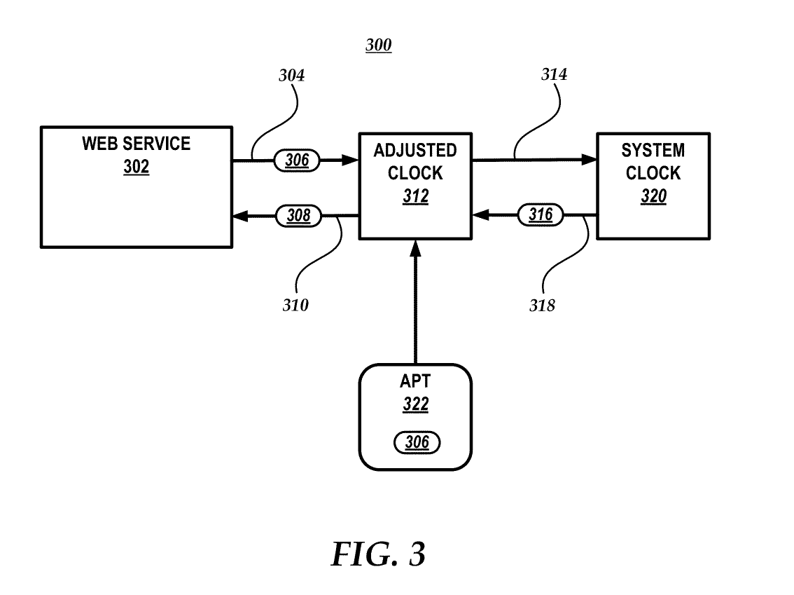

FIG. 3 is a block diagram of an example computer-based system 300 for adjusting system time data in which mechanisms described herein may be deployed. System 300 may be integrated with, or employed with, system 100, system 200, or a variation thereof. FIG. 3 is a simple block diagram of an example system. Various configurations may include other components, with operations distributed in a variety of ways.

Web service 302 may be Web services 106, Web service 208, worker process 232, worker process 234, a component thereof, or another process with logic to retrieve time data.

As illustrated in FIG. 3, in an example embodiment, Web service 302 sends a request 304 to adjusted clock 312. In one implementation, adjusted clock 312 is a software object, and request 304 is a method invocation, though other implementations may be used. Request 304 may include a time offset specification, referred to as time offset 306. The offset may be a positive or negative offset, representing a time in the future or the past. For example, an offset of −2 days may specify a time two days in the past. In one embodiment, adjusted clock 312 my retrieve time offset specification 306 from apartment 322 corresponding to request 304. In such an embodiment, passing the time offset specification 306 in request 304 may be omitted.

As illustrated, adjusted clock 312 may send a request 314 to system clock 320. In response, system clock 320 may return response 318 containing system time 316. After receiving system time 316, adjusted clock 312 may perform a calculation to determine an adjusted time based on the specified time offset 306 and system time 316. In some implementations, this may include converting the time offset specification units to match the system time, adding the time offset specification to the system time, or other calculations.

Adjusted clock 312 may then send response 310 back to Web service 302, the response containing adjusted time 308 as determined by adjusted clock 312.

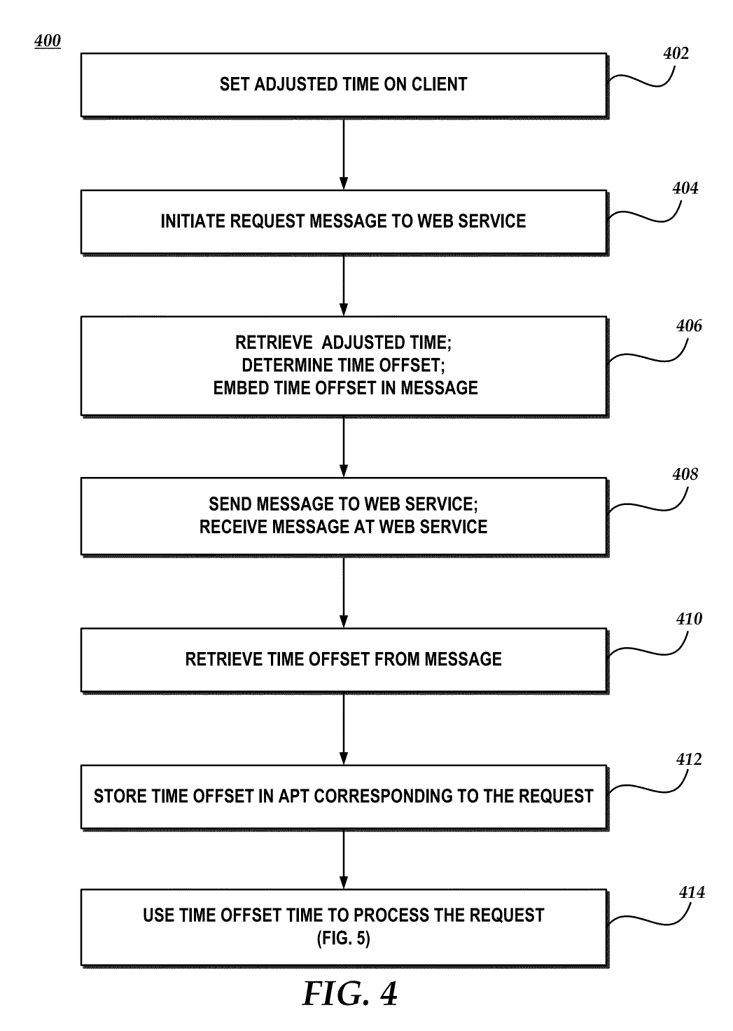

FIG. 4 is a flow diagram illustrating an example embodiment of a process 400 for manipulating a system property, such as system time, in accordance with some of the mechanisms described herein. Though system time is used as an example, embodiments may use other system properties. Process 400, or a portion thereof, may be performed by various embodiments of system 200, or variations thereof. Components of system 200 are used as examples of an implementation herein, though in various embodiments, the correspondence of process actions and components may vary. The illustrated portions of process 400 may be initiated at block 402, where an adjusted time, such as adjusted time 203, may be set on a client, such as client 202.

The process may flow to block 404, where a request message to a Web service may be initiated. This may include, for example, a client component configuring data in the form of a message, initiating a send message command, or other actions.

The process may flow to block 406, where the adjusted time may be retrieved from the client. A time offset specification may be determined, based on the client adjusted time and the system time of the client. The time offset specification may be embedded in the request message, or a transformation thereof. Time offset specification 220, embedded within request 204 is an example of this. In one embodiment, a component such as outgoing message inspector 240 may perform at least a portion of the actions of block 406.

The process may flow to block 408, where the request message is sent to a Web service, such as Web service 208. The request message may be received by the Web service. In some configurations, additional components may act as intermediaries of the message sending, though the message is considered to be sent to the Web service, regardless.

The process may flow to block 410, where the time offset specification may be retrieved from the request message received by the Web service. At block 412, the retrieved time offset specification may be stored in an apartment corresponding to the request message. Apartment 210 is an example of such an apartment. Block 412 may include creating the apartment corresponding to the request message. In one embodiment, a component such as incoming message inspector 242 may perform actions of one or more of blocks 410, 412, or portions thereof. Incoming message inspector may receive the request message.

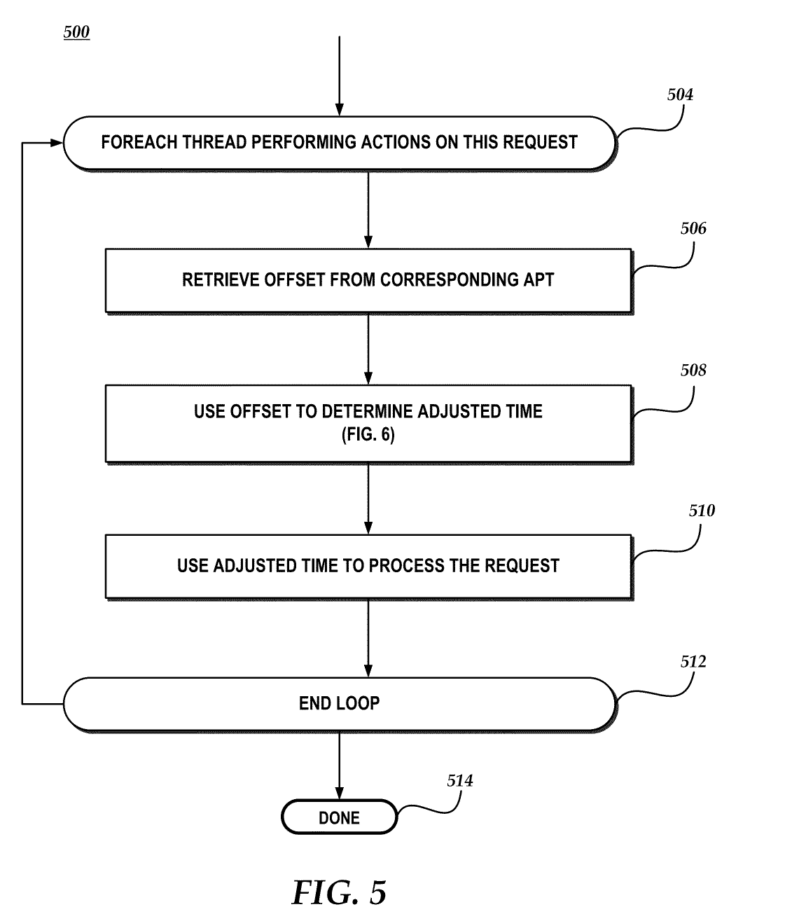

The process may flow to block 414, where the time offset may be used to process the request. The manner in which the time offset is used may vary, based on the business logic of the Web service handling the request. In one embodiment, the actions of block 414 may include retrieving the time offset from the apartment in which it is contained, determining an adjusted time setting, and using the adjusted time setting to perform operations related to the request. An example embodiment of such actions is illustrated in FIG. 5, and discussed herein.

The process may perform other actions, not shown, or exit.

FIG. 5 is a flow diagram illustrating an example embodiment of a process 500 for using a manipulated system property, such as an adjusted time, to process a request, in accordance with some of the mechanisms described herein. Process 500 may be used to implement at least a portion of block 414 of FIG. 4. In one embodiment, process 500 may be performed by Web service 208. The illustrated portions of process 500 may be initiated at block 504, which begins a loop that iterates for each thread performing actions on the request. The loop is referred to herein as loop 504. It includes blocks 506-510, and is terminated by block 512. In various environments, loop 504, may iterate, zero, one, or more times. The term “current request” is used herein to refer to the request that is being processed by the actions of process 500. This may be the offset stored at block 412 of FIG. 4. In the illustrated embodiment, the offset is a time offset.

Within loop 504, the process may flow to block 506, where a time offset may be retrieved from an apartment, such as apartment 210 of FIG. 2, corresponding to the current request.

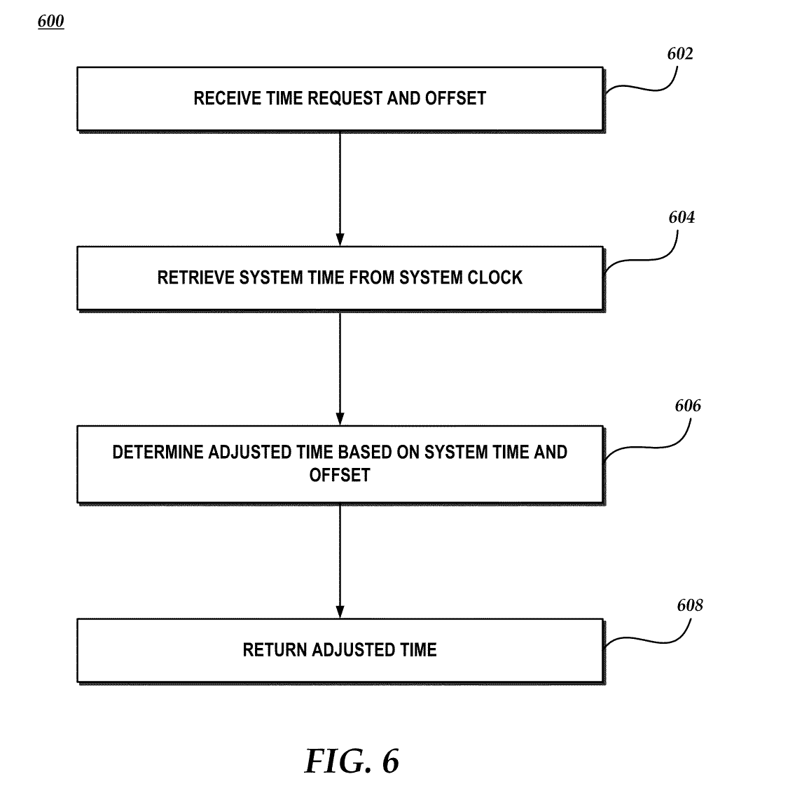

The process may flow to block 508, where the retrieved time offset may be used to determine an adjusted time corresponding to the current request. An example embodiment of a process of determining an adjusted time is illustrated in FIG. 6. The process may flow to block 510, where the determined adjusted time may be used to process the request. This processing may be in accordance with various business logic associated with the Web service and the request. For example, if the request is a request to record a payment, the processing of block 510 may include recording a payment using the adjusted time as the time of the payment.

The process may flow to block 512. At block 512, upon completion of the iterations, loop 504 may exit. The process may flow to done block 514. The process may flow to other actions, not shown, exit or return to a calling program.

FIG. 6 is a flow diagram illustrating an example embodiment of a process 600 for determining a manipulated system property, such as an adjusted time, in accordance with some of the mechanisms described herein. Process 600 may be used to implement at least a portion of block 508 of FIG. 5. In one embodiment, process 600 may be performed by adjusted clock 312 of FIG. 3. The illustrated portions of process 600 may be initiated at block 602, where a request for an adjusted system time is received. The request may include a time offset. In the example embodiment of FIG. 3, this request may be request 304, containing time offset 306.

The process may flow to block 604, where a system time may be retrieved from a system clock. In one implementation, the actions of block 604 may include sending a request, such as request 314, to system clock 320, and receiving response 318 containing system time 316.

The process may flow to block 606, where an adjusted time may be determined, based on the system time and the time offset. The process may flow to block 608, where the determined adjusted time may be returned to the requester. As illustrated in FIG. 3, in one implementation, adjusted time 308 may be returned in response 310 to a requesting Web service. The process may flow to other actions, not shown, exit or return to a calling program.

The mechanisms described herein may be used to test a computer system. For example, an adjusted time may be used to simulate operations performed at a time other than the current system time, in the future or in the past. A test may be performed without disturbing the system time on the computing devices, so that other operations that access the system time are not affected. In this way, tests may be performed in a system while the system is “live,” or multiple tests may be performed concurrently, each having a different adjusted system time.

The mechanisms may be used to perform recovery operations. For example, in a situation in which the system failed temporarily, an administrator may execute commands to perform the failed operations, simulating a time in the past when the original operations were to be performed. This may allow for proper construction or reconstruction of data. Such recovery may be performed without modifying the current system time. This allows the system to be used for “live” operations, to communicate correctly with other systems, for multiple concurrent recoveries, or for other reasons.

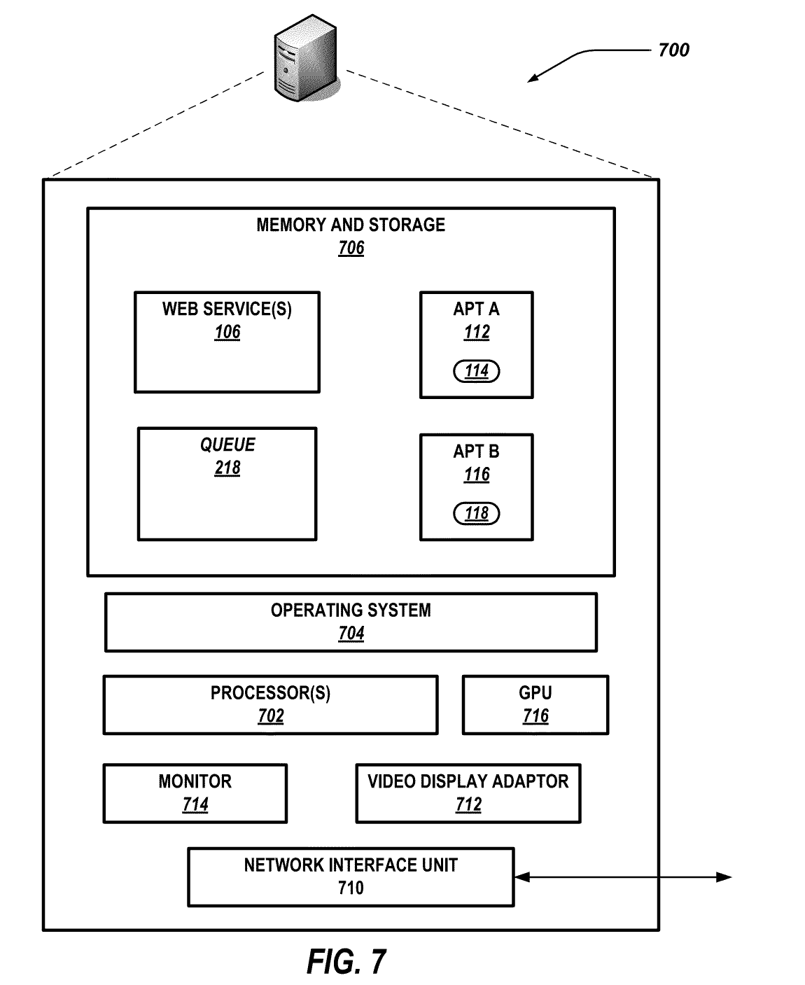

FIG. 7 is a block diagram showing one embodiment of a computing device 700, illustrating selected components of a computing device that may be used to implement mechanisms described herein, including system 200 and at least portions of processes 400, 500, or 600. Computing device 700 may include many more components than those shown, or may include less than all of those illustrated. Computing device 700 may be a standalone computing device or part of an integrated system, such as a blade in a chassis with one or more blades. Though the components of computing device 700 are illustrated as discrete components, any one or more of them may be combined or integrated into an integrated circuit, such as an ASIC.

As illustrated, computing device 700 includes one or more processors 702, which perform actions to execute instructions of various computer programs. In one configuration, each processor 702 may include one or more central processing units, one or more processor cores, one or more ASICs, cache memory, or other hardware processing components and related program logic. Computing device 700 may be a multi-threaded system. As illustrated, computing device 700 includes an operating system 704. Operating system 704 may be a general purpose or special purpose operating system. The Windows® family of operating systems, by Microsoft Corporation, of Redmond, Wash., includes examples of operating systems that may execute on computing device 700. In one embodiment, operating system 704 may execute on a virtual machine. A virtual machine is a software implementation of a computing device that executes an operating system and programs. Each virtual machine may be isolated from other virtual machines on a common computing device. Windows Azure™ is one example of a platform that provides virtual machines.

In one embodiment, computing device 700 includes one or more graphics processing units (GPU) 716. A GPU is a processor that is configured to perform graphics operations, such as rendering a graphic image, or to perform stream processing.

Memory and storage 706 may include one or more of a variety of types of computer storage media, including volatile or non-volatile memory, RAM, ROM, solid-state memory, disk drives, optical storage, or any other medium that can be used to store digital information.

Memory and storage 706 may store one or more components described herein or other components. In one embodiment, memory and storage 706 stores Web service 106, queue 218, apartment A 116 and associated time offset specification 118, or apartment B 120 and associated time offset specification 122. In various embodiments, one or more of these components may be omitted from memory and storage 706. In some embodiments, at least a portion of one or more components may be implemented in a hardware component, such as an ASIC. In various configurations, multiple components implementing the functions or including the data of these components may be distributed among multiple computing devices. Communication among various distributed components may be performed over a variety of wired or wireless communications mechanisms.

Any one or more of the components illustrated as stored in memory and storage 706 may be moved to different locations in RAM, non-volatile memory, or between RAM and non-volatile memory by operating system 704 or other components. In some configurations, these components may be distributed among one or more computing devices, including computing devices that are remotely located from each other.

Computing device 700 may include a video display adapter 712 that facilitates display of data, scene frames, or other information to a user. Though not illustrated in FIG. 7, computing device 700 may include a basic input/output system (BIOS), and associated components. Computing device 700 may also include a network interface unit 710 for communicating with a network. Software components, such as those stored in memory and storage 706, may be received via transitory media and network interface unit 710. Computing device 700 may include one or more display monitors 714. Embodiments of computing device 700 may include one or more input devices (not shown), such as a keyboard, pointing device, touch screen, keypad, audio component, microphone, voice recognition component, or other input/output mechanisms.

It will be understood that each block of the flowchart illustrations of FIGS. 4-6, and combinations of blocks in each flowchart illustration, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A computer-based method of modifying a system property corresponding to a request for a service, the method comprising:
a) receiving the request for the service, the request including a property adjustment;
b) storing the property adjustment in an apartment corresponding to the request; and
c) in response to a property request for an adjusted system property corresponding to the request for the service:
i) retrieving the property adjustment corresponding to the request for the service; and
ii) determining the adjusted system property corresponding to the request for the service based on the system property and the property adjustment.

2. The computer-based method of claim 1, the system property is a system time.

3. The computer-based method of claim 1, the system property is a system time and the property adjustment is a time offset specification.

4. The computer-based method of claim 3, further comprising in response to receiving the request for the service, creating the apartment corresponding to the request.

5. The computer-based method of claim 3, receiving the request for the service comprises at a first computing device, receiving the request for the service from a second computing device.

6. The computer-based method of claim 3, the apartment is stored in a logical call context corresponding to the request for the service, the method further comprising employing two or more threads that perform operations corresponding to the request for the service, each of the two or more threads retrieving the apartment from the logical call context corresponding to the request for the service.

7. The computer-based method of claim 3, further comprising receiving another request for another service, the other request including a time offset specification, storing the time offset specification in another apartment corresponding to the other request, and determining an adjusted time corresponding to the other request based on the system property and the time offset specification.

8. The computer-based method of claim 3, further comprising employing the adjusted system property to simulate performing operations at a time different from the system time.

9. The computer-based method of claim 3, further comprising sending the service request with the time offset specification in a message header.

10. The computer-based method of claim 3, further comprising:
storing data representative of the service request in a queue entry, the queue entry having corresponding data representative of the time offset specification; and
retrieving the queue entry and employing the time offset specification to determine the adjusted time.

11. A computer-based system, comprising:
a) data storage that stores a set of time offset specifications, each time offset specification corresponding to a respective request for a service;
b) a message handling component configured to perform actions, including:
i) receiving a request message containing a time offset specification;
ii) retrieving the time offset specification from the request message;
iii) storing the time offset specification in the set of time offset specifications; and
c) an adjusted clock component configured to perform actions, including:
i) receiving a time request;
ii) retrieving a time offset specification corresponding to the time request; and
iii) determining an adjusted time corresponding to the request message based on the time offset specification.

12. The computer-based system of claim 11, further comprising one or more processors configured to implement the message handling component and the adjusted clock component.

13. The computer-based system of claim 11, the set of time offset specifications stored in a memory component that is accessible to a plurality of threads, the computer-based system comprising at least two threads that perform operations corresponding to the request message, each thread retrieving the time offset specification corresponding to the request message.

14. The computer-based system of claim 11, further comprising a set of apartments, each apartment of the set of apartments including a corresponding time offset specification.

15. The computer-based system of claim 11, further comprising a plurality of computing devices, each computing device of the plurality of computing devices including a corresponding adjusted clock component having program logic to determine the adjusted time corresponding to the request message.

16. The computer-based system of claim 11, the computer storage is thread logical storage accessible by multiple threads.

17. The computer-based system of claim 11, further comprising a queue that receives a service request with data representative of the time offset specification, and stores the time offset specification in a queue entry.

18. A computer-readable storage medium comprising computer program instructions for modifying a system time property, the program instructions executable by one or more processors to perform actions including:
a) setting an adjusted time to a time other than a current time;
b) initiating a message;
c) retrieving the adjusted time;
d) determining a time offset specification based on the adjusted time;
e) embedding the time offset specification in a service request message; and
f) sending the service request message to a Web service.

19. The computer-readable storage medium of claim 18, the actions further comprising setting a plurality of adjusted times and sending a plurality of service request messages to the Web service, each request message corresponding to an adjusted time of the plurality of adjusted times.

20. The computer-readable storage medium of claim 18, the actions further comprising testing the Web service by concurrently sending a plurality of request messages, each request message having a corresponding adjusted time different from other adjusted times.
